(19) United States
(12) Patent Application Publication
(10) Pub. No.: US 2013/0088197 A1
(43) Pub. Date: Apr. 11, 2013

(54) APPARATUS FOR CHARGING BATTERY OF VEHICLE AND METHOD THEREOF

(71) Applicants: Jae Young KIM, Daegu (KR); Kee Koo KWON, Daegu (KR); Gwang Su KIM, Daejeon (KR)

(72) Inventors: Jae Young KIM, Daegu (KR); Kee Koo KWON, Daegu (KR); Gwang Su KIM, Daejeon (KR)

(73) Assignee: Electronics and Telecommunications Research Institute, Daejeon (KR)

(21) Appl. No.: 13/608,433

(22) Filed: Sep. 10, 2012

(30) Foreign Application Priority Data
Oct. 5, 2011 (KR) 10-2011-0101344

(51) Int. Cl. H02J 7/00

(52) U.S. Cl. 320/109

(57) ABSTRACT

Provided is a fast charging apparatus and method for a vehicle that may simultaneously charge a battery of a vehicle with electricity from at least two chargers through at least two charge connecting units provided to the vehicle.

### CROSS-REFERENCE TO RELATED APPLICATION

This application claims the priority benefit of Korean Patent Application No. 10-2011-0101344, filed on Oct. 5, 2011, in the Korean Intellectual Property Office, the disclosure of which is incorporated herein by reference.

### BACKGROUND

1. Field of the Invention

Embodiments of the present invention relate to technology of charging a battery of a vehicle with electricity.

2. Description of the Related Art

An electric vehicle is a vehicle to receive power using electricity, and has been used for a car, a truck, a bus, and the like. In an early stage of the electric vehicle industry, a driving distance has been limited due to a relatively low speed and recharge of a battery. Also, the electric vehicle may belong to a luxury item available in the city and thus, has been in a competitive relationship with an oil vehicle that is a freight transport vehicle connecting very proximate points. With time passing, the electric vehicle has been gradually falling behind in the competition with the oil vehicle due to a battery recharge issue.

Currently, the worldwide interest on the electric vehicle has been increasing in order to decrease a carbon dioxide emission occurring due to an environmental pollution. Also, efforts have been made on activation of the electric vehicle by constructing an infrastructure such as installation of a charging station for recharging a battery, and the like.

As a part for activating the electric vehicle, a smart grid is in the spotlight. The smart grid is a system that enables power to be most efficiently generated and consumed in such a manner that sensors may bi-directionally exchange information in real time and also exchange power at an optimal time. Also, electricity produced through a solar photovoltaic power generation and the like may be traded through an exchange. Accordingly, the power consumption may be reduced and commercialization in use of renewable energy may decrease the global warming.

However, since the above system has not been settled down so far, research on a method of charging a battery of an electric vehicle has been actively conducted.

Meanwhile, in addition to a method of constructing a system, a method of charging a battery of an electric vehicle with electricity has been variously developed. In the conventional art, the electric vehicle may be charged using a single charger, which is the same as an oil vehicle. In the case of fast charging, maximum 25 minutes to 30 minutes may be used to charge a battery of the electric vehicle with electricity and thus, a relatively very long amount of time may be used for charging.

Accordingly, there is a desire for a method capable of quickly charging a battery of an electric vehicle.

### SUMMARY

Embodiments of the present invention provide a fast charging apparatus and method for a vehicle that may simultaneously charge a battery of a vehicle with electricity from a plurality of chargers and may provide a plurality of charge connecting units to the vehicle.

Embodiments of the present invention also provide a fast charging apparatus and method for a vehicle that may significantly enhance a charging speed by providing at least two charge connecting units to a vehicle, and by charging a battery of the vehicle with electricity through the at least two charge connecting units.

According to an aspect of the present invention, there is provided a fast charging apparatus for a vehicle, the apparatus including: a first charge connecting unit mounted to the vehicle to be supplied with electricity from a first charger; and a second charge connecting unit being mounted to the vehicle to be supplied with electricity from a second charger at the same time with the first charge connecting unit.

The fast charging apparatus may further include a battery mounted to the vehicle to be charged with the electricity that is supplied through the first charge connecting unit and the second charge connecting unit.

According to another aspect of the present invention, there is provided a fast charging apparatus for a vehicle, the apparatus including a plurality of charge connecting units mounted to the vehicle to be supplied with electricity from a plurality of chargers, and to charge a battery of the vehicle with the supplied electricity.

According to still another aspect of the present invention, there is provided a fast charging method for a vehicle, the method including: providing at least two charge connecting units when manufacturing the vehicle; and supplying electricity to the at least two charge connecting units from at least two chargers when the at least two charge connection units are connected to the at least two chargers for supplying the electricity, respectively.

The fast charging method may further include charging a battery of the vehicle with the electricity supplied through the at least two charge connecting units. The fast charging method may further include controlling the vehicle to generate power using the electricity charged in the battery.

### EFFECT OF THE INVENTION

According to embodiments of the present invention, when manufacturing a vehicle, a plurality of charge connecting units may be provided to the vehicle in advance so that a battery of the vehicle may be simultaneously charged with electricity from a plurality of chargers.

Also, according to embodiments of the present invention, it is possible to significantly enhance a charging speed by providing at least two charge connecting units to a vehicle, and by charging a battery of the vehicle with electricity through the at least two charge connecting units.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of a fast charging apparatus for a vehicle according to an embodiment of the present invention;

FIG. 2 is a block diagram illustrating a configuration of a fast charging apparatus for a vehicle according to another embodiment; and

FIG. 3 is a flowchart illustrating a fast charging method for a vehicle according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, various embodiments of the present invention will be described with reference to the accompanying drawings, but the present invention is not limited thereto or restricted thereby.

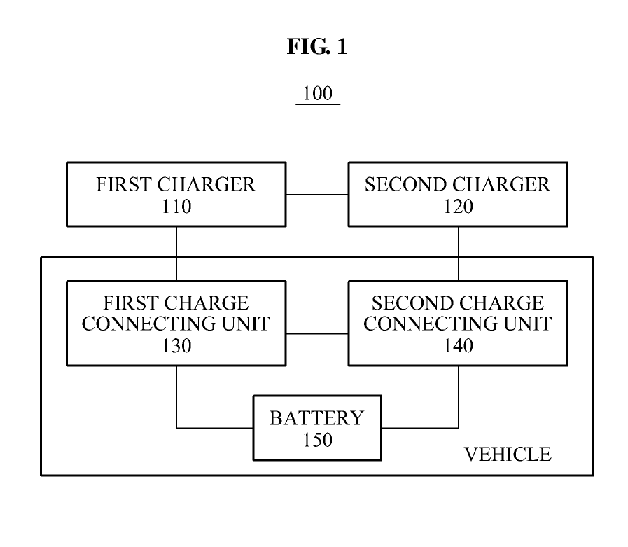

FIG. 1 is a block diagram illustrating a configuration of a fast charging apparatus for a vehicle 100 (hereinafter, referred to as a fast charging apparatus) according to an embodiment of the present invention.

Referring to FIG. 1, the fast charging apparatus 100 may include a first charge connecting unit 130, a second charge connecting unit 140, and a battery 150.

The fast charging apparatus 100 may be mounted to the vehicle when manufacturing the vehicle. In general, the vehicle has a single oil filling port. According to an embodiment of the present invention, two charge connecting units, for example, the first charge connecting unit 130 and the second charge connecting unit 140 may be provided to function as an oil filling port of the vehicle.

A first charger 110 may supply electricity to the vehicle. The first charger 110 may supply the electricity to the vehicle, which is similar to a charger of a gas station. For example, when the first charger 110 is connected to the first charge connecting unit 130 mounted to the vehicle, the first charger 110 may supply the electricity to the first charge connecting unit 130.

A second charger 120 may supply electricity to the vehicle. For example, when the second charger 120 is connected to the second charge connecting unit 140 mounted to the vehicle, the second charger 120 may supply the electricity to the second charge connecting unit 140. At the same time when the first charger 110 supplies the electricity to the first charge connecting unit 130, the second charger 120 may also supply the electricity to the second charge connecting unit 140.

The first charge connecting unit 130 may be mounted to the vehicle, and may correspond to the first charger 110. When the first charge connecting unit 130 is connected to the first charger 110, the first charge connecting unit 130 may be supplied with electricity from the first charger 110.

The second charge connecting unit 140 may be mounted to the vehicle, and may correspond to the second charger 120. When the second charge connecting unit 140 is connected to the second charger 120, the second charge connecting unit 140 may be supplied with electricity from the second charger 120.

A battery 150 may be charged with the electricity that is supplied through the first charge connecting unit 130. Also, the battery 150 may be charged with the electricity that is supplied through the second charge connecting unit 140.

Accordingly, when manufacturing the vehicle, the fast charging apparatus 100 may include the first charge connecting unit 130 and the second charge connecting unit 140 so that the first charger 110 and the second charger 120 may simultaneously charge the battery 150, and thereby may significantly enhance a charging speed.

Depending on embodiments, the fast charging apparatus 100 may include at least two charge connecting units.

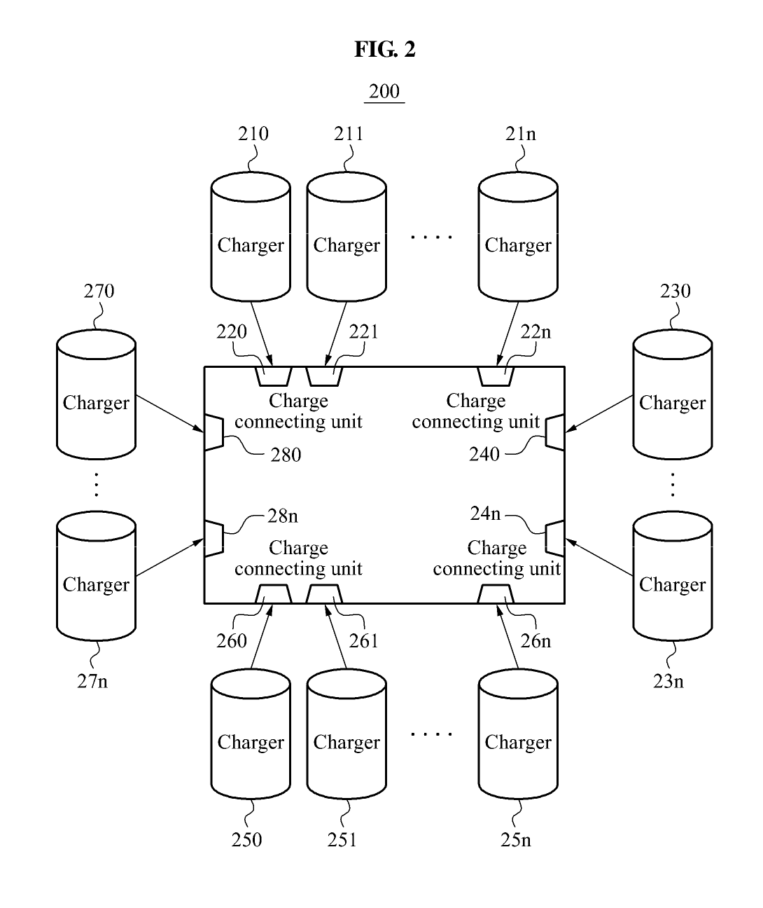

FIG. 2 is a block diagram illustrating a configuration of a fast charging apparatus 200 for a vehicle according to another embodiment of the present invention.

Referring to FIG. 2, when manufacturing the vehicle, the fast charging apparatus 200 may include a plurality of charge connecting units 220 to 22n, 240 to 24n, 260 to 26n, and 280 to 28n.

The plurality of charge connecting units 220 to 22n, 240 to 24n, 260 to 26n, and 280 to 28n may be mounted to the vehicle, may be supplied with electricity from a plurality of chargers 210 to 21n, 230 to 23n, 250 to 25n, and 270 to 27n, respectively, and may charge a battery of the vehicle with the supplied electricity.

For example, the charge connecting unit 220 may correspond to the charger 210. When the charge connecting unit 220 is connected to the charger 210, the charge connecting unit 220 may be supplied with electricity from the charger 210, and may charge the battery of the vehicle with the supplied electricity. The charge connecting unit 220 may correspond to the charger 211. When the charge connecting unit 221 is connected to the charger 211, the charge connecting unit 221 may be supplied with electricity from the charger 211, and may charge the battery of the vehicle with the supplied electricity. Also, the charge connecting unit 22n may correspond to the charger 21n. When the charge connecting unit 22n is connected to the charger 21n, the charge connecting unit 22n may be supplied with electricity from the charger 21n, and may charge the battery of the vehicle with the supplied electricity.

Similarly, the charge connecting unit 240 may correspond to the charger 230. When the charge connecting unit 240 is connected to the charger 230, the charge connecting unit 240 may be supplied with electricity from the charger 230, and may charge the battery of the vehicle with the supplied electricity. The charge connecting unit 24n may correspond to the charger 23n. When the charge connecting unit 24n is connected to the charger 23n, the charge connecting unit 24n may be supplied with electricity from the charger 23n, and may charge the battery of the vehicle with the supplied electricity.

Similarly, when manufacturing the vehicle, a plurality of other charge connecting units may be mounted to the vehicle to correspond to a plurality of chargers, respectively, and thereby may be supplied with electricity from the respective corresponding chargers, and may supply the battery of the vehicle with the supplied electricity.

Accordingly, when manufacturing a vehicle, the fast charging apparatus 200 may mount a plurality of charge connecting units to the vehicle in advance and thereby enable the plurality of charge connecting unit to be simultaneously supplied with electricity from a plurality of chargers, respectively, and to supply a battery of the vehicle with the supplied electricity. Therefore, it is possible to significantly enhance a charging speed.

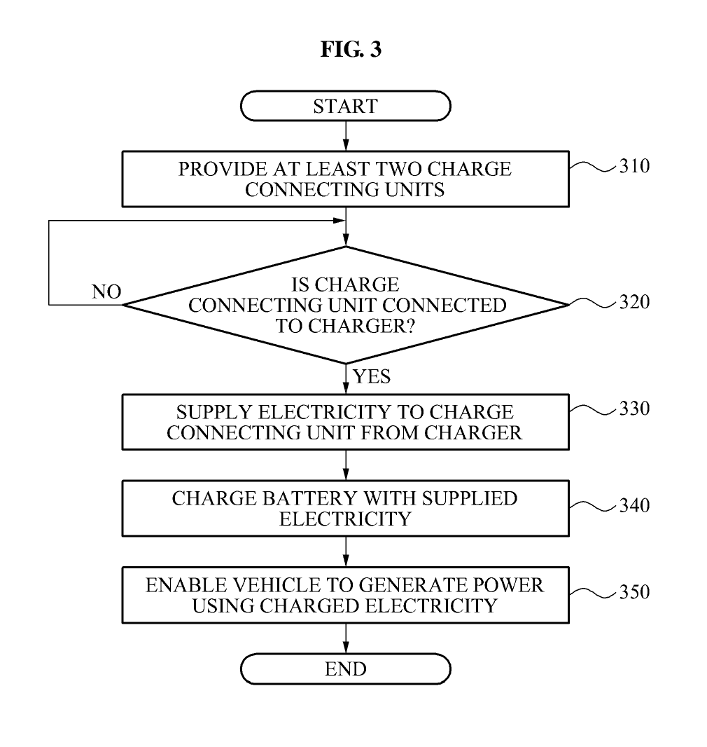

FIG. 3 is a flowchart illustrating a fast charging method for a vehicle according to an embodiment of the present invention.

The method of FIG. 3 may be performed by the fast charging apparatus 100 of FIG. 1 or the fast charging apparatus 200 of FIG. 2.

Referring to FIG. 3, in operation 310, a fast charging apparatus may mount at least two charge connecting units to a vehicle when manufacturing the vehicle. To increase a speed of supplying electricity to the vehicle, the fast charging apparatus may separately include at least two charge connecting units to be supplied with electricity from chargers.

Also, when manufacturing the vehicle, the fast charging apparatus may mount the number of charge connecting units to the vehicle in advance to correspond to the number of chargers. For example, when the number of chargers is two, the fast charging apparatus may mount two charge connecting units to the vehicle. When the number of chargers is five, the fast charging apparatus may mount five charge connecting units to the vehicle.

Accordingly, when manufacturing the vehicle, the fast charging apparatus may mount the number of a plurality of charge connecting units to the vehicle to correspond to the number of a plurality of chargers. For example, to efficiently supply electricity to the vehicle, the fast charging apparatus may mount the appropriate number of charge connecting units to the vehicle in advance when manufacturing the vehicle.

Hereinafter, a description will be made using an example in which the fast charging apparatus mounts at least two charge connecting units to the vehicle in advance when manufacturing the vehicle.

In operation 320, the fast charging apparatus may detect whether each of the at least two charge connecting units is connected to a corresponding charger. The charger may supply electricity to the vehicle.

In operation 330, when each of the at least two charge connecting units is detected to be connected to the corresponding charger, the fast charging apparatus may supply electricity to the at least two charge connecting units from at least two chargers, respectively.

In operation 340, the fast charging apparatus may charge a battery of the vehicle with the supplied electricity.

In operation 350, the fast charging apparatus may control the vehicle to generate power using the charged electricity.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A fast charging apparatus for a vehicle, the apparatus comprising:
a first charge connecting unit mounted to the vehicle to be supplied with electricity from a first charger; and
a second charge connecting unit being mounted to the vehicle to be supplied with electricity from a second charger at the same time with the first charge connecting unit.

2. The apparatus of claim 1, further comprising:
a battery mounted to the vehicle to be charged with the electricity that is supplied through the first charge connecting unit and the second charge connecting unit.

3. A fast charging apparatus for a vehicle, the apparatus comprising:
a plurality of charge connecting units mounted to the vehicle to be supplied with electricity from a plurality of chargers, and to charge a battery of the vehicle with the supplied electricity.

4. A fast charging method for a vehicle, the method comprising:
providing at least two charge connecting units when manufacturing the vehicle; and
supplying electricity to the at least two charge connecting units from at least two chargers when the at least two charge connection units are connected to the at least two chargers for supplying the electricity, respectively.

5. The method of claim 4, further comprising:
charging a battery of the vehicle with the electricity supplied through the at least two charge connecting units.

6. The method of claim 5, further comprising:
controlling the vehicle to generate power using the electricity charged in the battery.
